(19) United States
(12) Patent Application Publication
(10) Pub. No.: US 2010/0117262 A1
(43) Pub. Date: May 13, 2010

(54) METHOD OF DUAL MOLDING PRODUCTS WITH LOGOS AND OTHER INDICIA

(76) Inventor: Donald GRINGER, New York, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/269,996

(22) Filed: Nov. 13, 2008

(51) Int. Cl. B29C 39/10

(52) U.S. Cl. 264/247

(57) ABSTRACT

A method of dual injection molding is provided herewith. Generally, the method comprises the steps of providing a first mold to produce an inner portion of a product; forming the inner portion from a first plastic material such as polypropylene; providing an insert in the form of a logo or other indicia; combining the insert with the inner portion of the product; providing a second mold to receive the inner portion and insert combination; and injecting a second plastic material such as Santoprene® into the second mold around the core-insert combination, thereby forming a cover around the core and leaving at least one surface of the insert exposed so that it is visible.

### FIELD OF INVENTION

This present application relates to a method of incorporating indicia on a wide variety of products. More specifically, the invention involves a method of dual molding a permanent stamp or logo into a soft overmolded, hard core product. Even more particularly, the inventive method involves selectively positioning logos or indicia on products formed by dual molding without requiring fabrication of additional molds when different logos or indicia are incorporated.

### BACKGROUND OF THE INVENTION

A wide variety of consumer and industrial products are created through the process of injection molding. To produce such products, at least one mold is created from steel or other suitable metal or alloy that is capable of withstanding the temperature and pressure that accompanies the injection molding process. Traditionally, the mold is formed from two sections and is designed to receive a liquefied thermoplastic elastomer or other suitable plastic or material that is injected into the mold. The shape of the item that that is formed from the injection molding process is the inverse or negative of the interior surface of the mold that is exposed to the liquefied thermoplastic material.

One major problem with injection molding is the relatively high cost for creating a mold. The concern over high production costs for the creation of a mold is further magnified when a manufacturer molds the same product (or very similar product) for a number of different customers but each customer requires the incorporation its own logo and/or other indicia onto the surface of its own version of the product. In this case, because of the substantial differences in the logo or indicia, a separate mold (or at least a separate section of a mold) must be fabricated to produce each customer's individualized product. This is the case even though the product that is produced on behalf of one customer may otherwise be the same as (or very similar to) that produced with a different logo or indicia on behalf of one or more other customers. This situation may likewise occur where a single customer uses a number of different brand names or logos on the same type of product.

The deficiency in the process discussed above is clearly demonstrated in the context of U.S. Pat. No. 6,726,868, which is entitled Double Molding Process Whereby A Sign is Produced On A Product While Said Product Is Molded. In particular, U.S. Pat. No. 6,726,868 discusses a double molding process where visual information, such as a logo, name, trademark or symbol, is produced on a product while the product is being molded. The process involves the production of an inner core formed of a first molding material, where the core incorporates a cavity in the shape of the visual information or sign that is to be produced. The process also involves the molding of an outer cover formed of a second molding material onto the inner core. When the outer cover is molded, the material forming the outer cover fills the cavity producing the visual information on the product. The process of forming the inner core with a cavity that corresponds to the visual information necessarily requires the use of a mold that contains complementary projections to form the cavity in the inner core that corresponds to the visual information. Significantly, each time the visual information is modified, even though the product itself may not otherwise change (or change significantly), a different mold needs to be fabricated to produce the product.

The problem of having to create a different mold for a particular product when a different logo or indicia is incorporated into the same (or substantially similar) product is further experienced when a company wishes to produce the same dual injection molded product under three distinct brand-names. For example, in the case of a putty knife that is produced under distinct brand names, the blade and handle of each of brand of knife is the same (or nearly identical), but the logo different in each. The handle of all three is constructed utilizing the same dual molding process, where the inner core comprises a hard plastic and also forms an exposed logo or indicia, and the outer cover comprises a thermoplastic elastomer, such as Santoprene®, which forms a soft handle that covers all or a significant part of the inner core except for where the logo or indicia is exposed. In this situation, even though the handles are essentially the same, since the logo for each is different, three different molds are typically created in order to construct the handle. While the costs for creating three molds for a product can potentially be absorbed, the problem becomes significantly amplified when there are tens or hundreds of products to produce under multiple brand names that each requires a unique mold.

To overcome the issues discussed above, companies often resort to silk-screening, hot-stamping or pad printing logos on a product. However, this has proven to be an ineffective solution. While the quality of inks have improved over the years, they usually fade over time, particularly if the product is a handle, is handled regularly or is subject to repeated contact. Moreover, if the product has a soft surface, such as one made of Santoprene®, the imprint can be lost relatively quickly.

### SUMMARY OF THE INVENTION

In view of the deficiencies and drawbacks in the prior art, it is a primary object of the present invention to provide an improved method of dual injection molding that reduces the number of molds needed to produce products that incorporate different logos and/or other indicia but which are otherwise identical or substantially the same.

Another primary object of the present invention is to provide a method of producing dual injection molded products that is more efficient and provides cost savings to manufacturers.

Yet another object of the present invention is to overcome issues associated with silk-screening, hot-stamping or pad-printing a logo or other indicia on a product by providing a permanent insert that is molded (or otherwise created) from a hard plastic (such as polypropylene), soft elastomer (such as Santoprene®) or other suitable material.

Additional objectives will be apparent from the description of the invention that follows.

In summary, there is provided in a preferred embodiment of the present invention an improved method of injection molding that reduces the need to fabricate additional molds in order to create injection molded products having a logo and/or other visual indicia, and which also overcomes the problems associated with applying inks or other non-permanent indicia on a product. Generally, the method comprises the following steps:

a. providing a first mold to produce an inner portion or core of a product;

b. forming the inner portion or core from a first plastic material;

c. providing an insert in the form of a logo or other indicia;

d. attaching, engaging and/or combining the insert to the inner portion or core of the product;

e. providing a second mold to receive the core and insert combination; and

f. injecting a second plastic material into the second mold around the core-insert combination, thereby forming a cover around the core and leaving at least one surface of the insert exposed so that it is visible.

It should be understood that one or more steps may be added to those listed above, and that any one or more of the particular steps above may be removed or substituted by one or more other steps when appropriate, while still keeping within the spirit and scope of the present invention.

In a preferred embodiment of the present invention, the first plastic material used to form the core is a hard plastic, such as polypropylene. Also, in a preferred embodiment of the present invention, the second plastic material used to form the cover is a thermoplastic elastomer, such as Santoprene®.

By utilizing an insert that is constructed separate from and then combined with the inner portion of a product, the product can be manufactured under a host of different brand names by simply using different logo or indicia inserts with a particular inner portion. Through this method, a product can be manufactured with a different appearance without having to use a different mold (or series of molds) to create the product.

Generally, an insert is created quite inexpensively when it is molded, since a mold for producing the insert is quite small and of a fast cycle. During overmolding of the insert and core combination, the overmolding material, typically Santoprene®, is allowed to flow around closed parts of the insert via one or more channels.

### BRIEF DESCRIPTION OF THE DRAWINGS

With reference to the attached drawings:

FIG. 1 is a female mold section of a mold utilized in connection with the injection molding of an inner portion or core of a tool handle;

FIG. 2 is a cross section of a mold utilized in connection with the injection molding of the inner portion of a tool handle, the mold comprising one female mold section and one male mold section;

FIG. 3 is an inner portion of a tool handle created by an injection molding process utilizing the mold shown in FIG. 2;

FIG. 4 is a bottom, rear and left perspective view of a logo insert utilized in connection with the present invention;

FIG. 5 is a top view of the logo insert shown in FIG. 4;

FIG. 6 is a female mold section of a mold utilized in connection with the injection molding of a soft cover of a tool handle;

FIG. 7 is a cross section of a mold utilized in connection with the injection molding of the soft cover of a tool handle, the mold comprising one female mold section and one male mold section;

FIG. 8 is a partial cross section of the mold depicted in FIG. 7, showing the flow of a thermoplastic elastomer within the mold used to form the soft cover of a tool handle;

FIG. 9 is a tool handle with a logo and soft cover exterior formed utilizing the mold shown in FIG. 7; and

FIG. 10 is a partial cross section taken along line 10-10 of FIG. 9, showing the thermoplastic elastomer surrounding the logo insert.

### DETAILED DESCRIPTION OF THE INVENTION

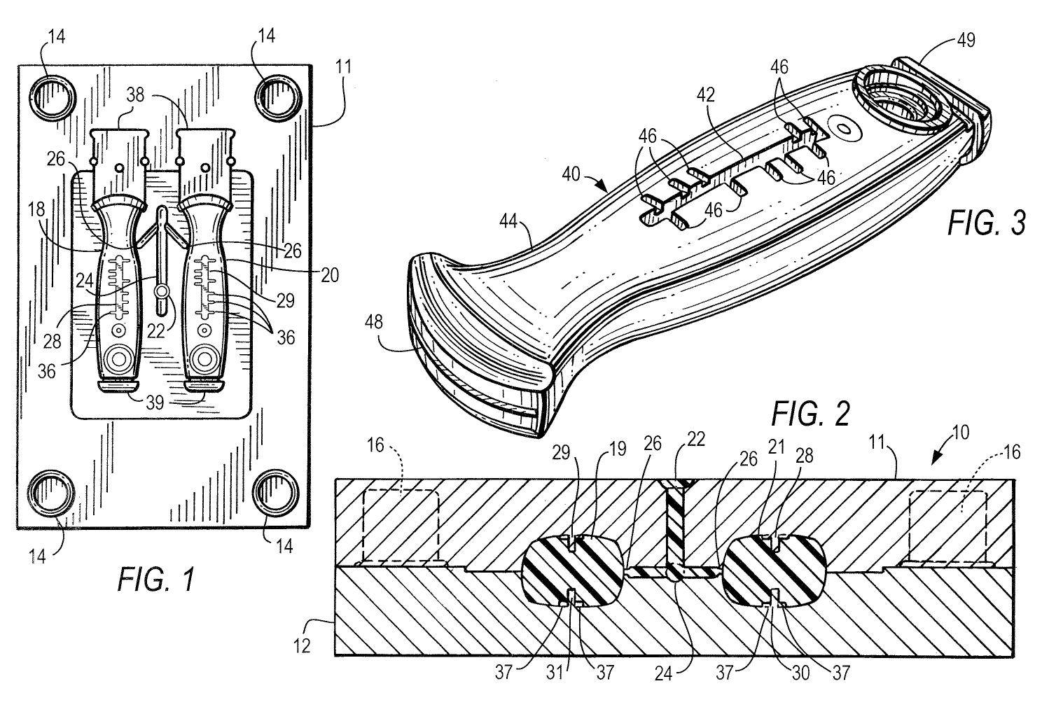

With reference to FIGS. 1 through 10, there is shown and described a method for injection molding products having logos or other indicia. The method comprises providing a first mold, mold set or die 10, a cross section of which is shown in FIG. 2. The first mold 10 has a female mold section 11 shown in FIG. 1 which has four apertures 14 at the corners thereof to receive correspondingly positioned cylinders or projections 16 of a complementary male mold section 12. It should be understood that each of the apertures 14 of the female mold section 11 and each of the correspondingly positioned projections 16 of the male mold section 12 are generally interchangeable with one another.

The female mold section 11 has two small wells or cavities 18, 20. In the context of the injection molding process used to create the particular tool handle 140 shown in FIG. 9, the male section 12 also has two small cavities, each of which has dimensions and features similar to those of cavities 18, 20. Although mold sections 11, 12 have dimensions and features that are similar to one another, it should be understood that the process described herein may also be utilized to create products with logos or other indicia using mold sections that vary from one another. When mold sections 11, 12 are joined, they form larger cavities 19, 21 as shown in FIG. 2. These larger cavities 19, 21 yield the contours, overall shape and other features of the inner portion or core 40, as shown in FIG. 3.

The female mold section 11 has an inlet 22 for receiving polypropylene or other suitable hard plastic (in liquefied form) into the mold 10. From the inlet 22, the polypropylene travels through a sprue 24, which is the arrow-shaped passage through which the liquid material travels to the mold 10 where it solidifies to form the core 40. Just before entering the cavities 19, 21, the liquid material passes through a gate 26. The location of the gate 26 is often seen as a small nub or projection called a “gate mark” on the outside edge of the piece that is molded. Optionally, a runner or larger channel may be provided as well. When a runner is incorporated, a sprue is provided as a smaller channel that diverts from the runner to the individual part(s) that are molded.

The cavities 18, 20 of the female mold section 11 each have a projection 28, 29 that preferably extends along the length of each cavity 18, 20, respectively. The projections 28, 29 form a relatively thin ridge that is preferably about two inches in length. The dimensions (i.e., length, width and height) of the projections 28, 29 can be modified as needed. Further, the cavities of the male mold section 12 have projections 30, 31 with features and dimensions identical to those of projections 28, 29, but which can be modified or entirely eliminated as desired. The purpose of each of the projections 28, 29, 30, 31 is to form a corresponding receiving slot or pocket 42 in the inner portion or core 40, as shown in FIG. 3.

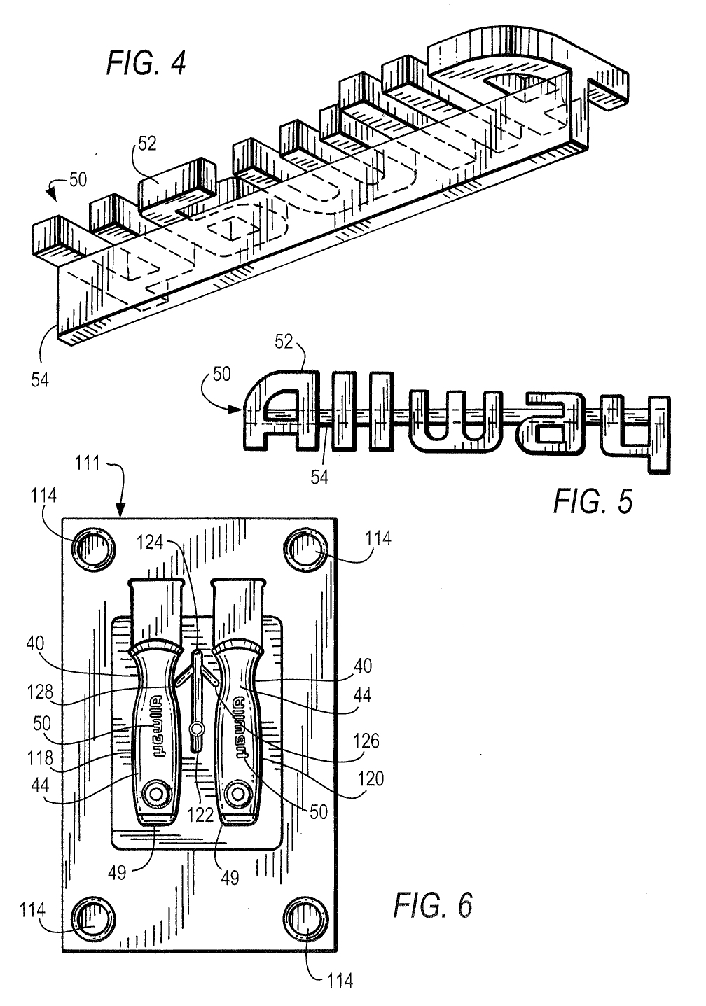

The receiving slot 42 on the surface 44 of the core 40 receives a logo insert 50 or insert that incorporates other visual indicia. One example of a logo insert 50 is shown in FIGS. 4 and 5, namely the trademark “Allway.” In a preferred embodiment, the logo insert 50 includes a logo portion 52 and a rail or ledge 54 that fits into receiving slot 42. In order for the rail 54 to rest properly and snugly in the receiving slot 42, each of the projections 28, 29, 30, 31 is formed with suitable dimensions such that the receiving slot 42 that is formed in the core 40 is large enough to receive the rail 54 of the logo insert 50. Preferably, the rail 54 fits snugly into the receiving slot 42 so that logo insert 50 is not easily dislodged. It should also be understood that other conventional means to connect an insert to a core can be employed besides the slot 42 and rail 54 combination. Furthermore, in order to accommodate a wide variety of logo and indicia inserts without having to fabricate an entirely new mold or mold section, it is desirable that the length of the receiving slot be long enough to accommodate approximately 1-20 alphanumeric characters. In addition to including traditional letters and numbers, it should be understood that an alphanumeric character may also comprise symbols which are not traditional letters or numbers. Of course, the length of the slot can be modified as needed depending on the products being manufactured.

The female mold section 11 preferably includes a series of traversing ridges or projections 36. In a preferred embodiment, the projections 36 are generally perpendicular to projections 28, 29. Traversing projections 36 in the female mold section result in a number of short channels 46 on the surface 44 of the core 40. Traversing projections 37 are also provided on the male mold section 12 to create a series of short channels on the opposite side of the core 40 as well.

The female mold section 11 also provides spaces 38 within which a mock blade or blade substitute is inserted. The insertion of a mock blade in the mold 10 creates a corresponding opening 48 at the front of the core 40 to receive a blade or other working tool end. Spaces 39 are also provided within which a metallic hammer end 49 can be inserted and provided as part of the core 40.

After the core 40 is formed, a logo insert 50 is positioned in the receiving slot 42 so that the insert 50 is attached to, engaged or combined with the core 40. The core-insert combination is then placed in a second mold, mold set or die 110. The second mold 110 has a female mold section 111 shown in FIG. 6 which has four apertures 114 at the corners thereof to receive correspondingly positioned cylinders or projections 116 of a complementary male mold section 112. It should be understood that each of the apertures 114 of the female mold section 111 and each of the correspondingly positioned projections 116 of the male mold section 112 are generally interchangeable with one another.

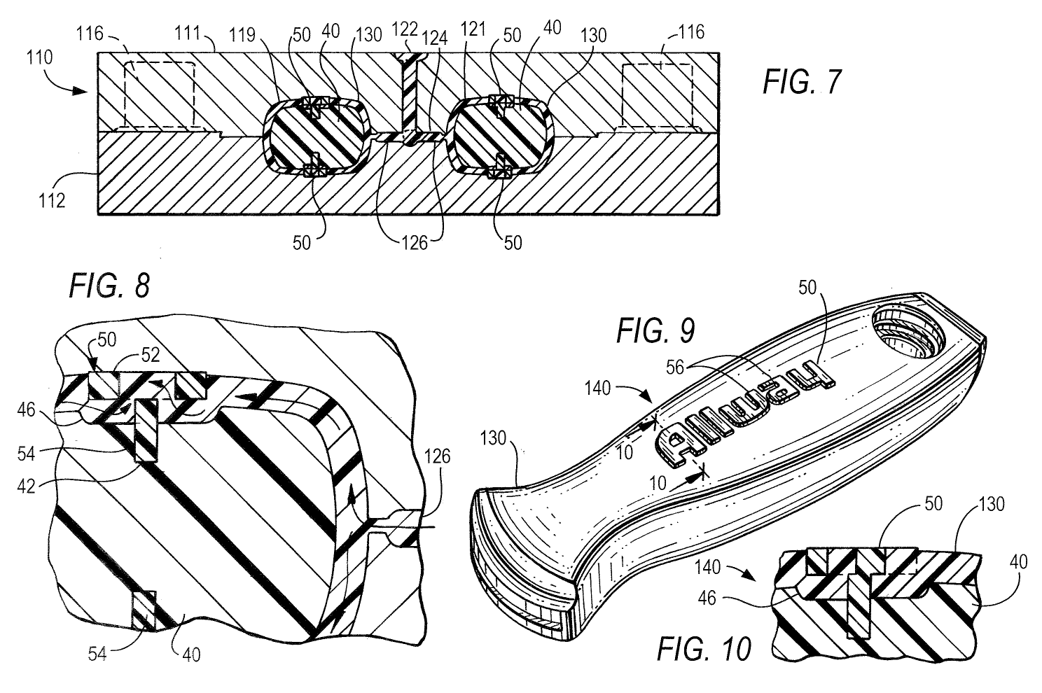

The female mold section 111 has two small wells or cavities 118, 120 that each receives a single core 40. In this instance, each core 40 comprises two logo inserts 50, but it should be understood that more or less inserts may be utilized. In the context of the injection molding process used to create the particular tool handle 140 shown in FIG. 9, the male section 112 also has two small cavities, each of which has dimensions and features similar to those of cavities 118, 120. Although mold sections 111, 112 have dimensions and features that are similar to one another, it should be understood that the process described herein may also be utilized to create products with logos or other indicia using mold sections that vary from one another. When mold sections 111, 112 are joined, they form larger cavities 119, 121 as shown in FIG. 7. These larger cavities 119, 121 yield the contours, overall shape and other features of the finished handle 140, as shown in FIG. 9.

The female mold section 111 has an inlet 122 for receiving Santoprene® or other suitable thermoplastic elastomer (in liquefied form) into the mold 110 around the core 40 and logo insert 50. From the inlet 122, the Santoprene® travels through a sprue 124 through which the liquefied Santoprene® travels to the mold 110 where it solidifies to form a soft exterior cover 130. Just before entering the cavities 119, 121, the liquid Santoprene® passes through a gate 126. Optionally, a runner or larger channel may be provided as well. When a runner is incorporated, a sprue is provided as a smaller channel that diverts from the runner to the individual part(s) that are molded.

The path of the flowing thermoplastic elastomer within the mold 110 used to form the soft cover 130 is shown in FIG. 8. The elastomer enters the mold 110 at the gate 126 and flows around the core 40. As a result of the channels 46 which are incorporated into the surface 44 of the core 40, the elastomer is able to proceed between the surface 44 of the core 40 and the logo portion 52 of the logo insert 50. The channels allow the flowing elastomer to reach the closed spaces of an alphanumeric character, symbol, logo or the like as shown in FIGS. 8 and 10. For example, alphanumeric characters which incorporate closed spaces include the letters A, B, D, O, P, Q and R, and the numbers 0, 4, 8 and 9. By entering the closed space from beneath the logo portion 52, the elastomeric material fills in each available space of the insert 50.

As an alternative to or in conjunction with providing channels 46 on the surface 44 of the core 40, the logo insert 50 may be elevated or raised relative to the surface 44 of the core. Elevating the insert 50 serves a similar function as that afforded by the channels 46, allowing the elastomeric material to flow beneath logo portion 52 of the insert 50 into closed spaces. Elevating the insert 50 may be accomplished by forming a receiving slot 42 that is more shallow than the height of the rail 54 of the logo insert 50.

After cooling of the thermoplastic elastomer, a soft cover 130 is formed around the core 40 and logo insert 50 as shown in FIG. 9, leaving the exterior surface 56 of the logo portion 52 visually exposed. Preferably, the exterior surface 56 is flush with the surrounding cover 130. It should also be appreciated that the thickness of the cover can be adjusted as desired by adjusting the size of the mold cavities and/or by adjusting the diameter or thickness of the core. Thus, for example, assuming the size of the core is kept constant, a larger mold cavity yields a thicker exterior cover.

Using the dual injection molding process described above, one pair of molds can be used to create a given product with a variety of logos or other visual indicia. For example, when one tool is manufactured under four different brand names by employing a dual injection molding process, only one pair of molds is required instead of four pairs of molds.

Even taking into account a separate mold that may be used to create the logo insert itself, the cost savings are still significant, particularly when many different products using many different brand names are manufactured. For example, if four different products having four different logos are created, up to 32 different molds would need to be fabricated using conventional methods of manufacture: 16 molds for each of the 16 different cores, and then up to 16 molds to create the soft cover exterior. If the soft cover exterior molds can be re-used regardless of the logo that is incorporated, then only 4 need to be fabricated, but if not, up to 16 would need to be fabricated. In contrast, using the inventive process described herein, only 12 molds need to be fabricated: 4 molds for the logo inserts, 4 molds to create each of the cores, and 4 molds to create the soft cover exterior. The savings on mold fabrication is alone is evident, and is even more significant when there are a larger number of products and logos to be created.

It should be understood that a logo insert can be constructed out the same or different material than the material used to form a core. For example, instead of polypropylene or other hard plastic, any suitable metal or soft Santoprene® can be used. When molding a logo insert, a separate mold or die (which is similar in many basic respects to the mold 10 used to create the core 40) is provided to receive the polypropylene or other hard plastic in the shape of the logo insert. It should further be understood that when utilizing both an insert and cover that are formed of the same thermoplastic elastomer such as the soft Santoprene® it is preferable to utilize different colored materials so that there is a contrast between the insert and cover.

It should be understood that the process described herein can be applied to the manufacture of a host of different products, not just tool handles as exemplified in a preferred embodiment of the invention. In particular, the process can be applied to any product that incorporates an embedded logo or indicia and which is dual injection molded, having a hard plastic core covered with a soft thermoplastic exterior.

Although the invention is described in terms of particular embodiments, it is to be understood that the embodiments are merely illustrative of an application of the principles of the invention. In particular, while the invention is described primarily in terms of a method of dual injection molding of a tool handle featuring visual material, it should be understood that a number of other products can be constructed using the process described herein. It should also be appreciated that numerous modifications may be made and other arrangements may be devised while still keeping within the spirit and scope of the invention.

1. A method of dual injection molding a product featuring visual material, comprising the steps of:
providing a first mold to produce a core of said product;
injecting a first plastic material in liquefied form into said first mold and forming said core from said first plastic material;
providing an insert representing said visual material and engaging said the insert with said core;
providing a second mold to receive said core and insert; and
injecting a second plastic material in liquefied form into said second mold around said core and said insert, thereby forming a cover around said core and leaving a surface of said insert exposed.

2. The method of claim 1, wherein said first plastic material is a hard plastic material.

3. The method of claim 2, wherein said hard plastic material is polypropylene.

4. The method of claim 1, wherein said second plastic material is a thermoplastic elastomer.

5. The method of claim 4, wherein said thermoplastic elastomer is Santoprene®.

6. The method of claim 1, wherein said visual material comprises a logo formed of polypropylene or Santoprene.

7. The method of claim 6, wherein said logo comprises at least one alphanumeric character.

8. The method of claim 1, wherein said first mold comprises at least one longitudinal projection that forms a receiving slot in said core.

9. The method of claim 8, wherein said insert has a rail that fits into said receiving slot.

10. The method of claim 9, wherein said insert further has at least one alphanumeric character and said rail holds said at least one alphanumeric character.

11. The method of claim 1, wherein said insert comprises at least one closed space and said first mold comprises at least one traversing projection that forms at least one channel on a surface of said core to allow said second plastic material to fill in said at least one closed space.

12. The method of claim 11, wherein said second plastic enters said at least one closed space from behind said insert.

13. The method of claim 1, further comprising the steps of
providing a third mold to produce said insert; and
injecting a third plastic material in liquefied form into said third mold and forming said insert from said third plastic material.

14. The method of claim 13, wherein said third plastic material is the same as said first plastic material.

15. The method of claim 13, wherein said third plastic material is the same as said second plastic material but of a different color.

16. A method of dual injection molding a product having a plurality of different indicia comprising the steps of:
providing a first mold to produce a first plurality of cores and a second plurality of cores wherein said first plurality of cores is the same as said second plurality of cores;
injecting a first plastic material into said first mold and forming said first plurality of cores and said second plurality of cores from said first plastic material;
providing a first plurality of inserts and combining said first plurality of inserts with said first plurality of cores;
providing a second plurality of inserts that are different from said first plurality of inserts and combining said second plurality of inserts with said first plurality of cores;
providing a second mold to receive said first plurality of inserts with said first plurality of cores, and said second plurality of inserts with said first plurality of cores; and
injecting a second plastic material into said second mold around said cores and inserts, thereby forming a cover around said cores and leaving a surface of said inserts exposed.

17. The method of claim 16, wherein said first plastic material is a hard plastic material.

18. The method of claim 17, wherein said hard plastic material is polypropylene.

19. The method of claim 16, wherein said second plastic material is a thermoplastic elastomer.

20. The method of claim 19, wherein said thermoplastic elastomer is Santoprene®.

21. The method of claim 16, wherein said insert comprises visual indicia.

22. The method of claim 21, wherein said visual indicia comprises a logo.

23. The method of claim 16 wherein said first mold comprises a longitudinal projection that forms a receiving slot in said cores.

24. The method of claim 23, wherein said insert has a rail that fits into said receiving slot.

25. The method of claim 16, wherein said insert comprises at least one closed space and said first mold comprises at least one traversing projection that forms at least one channel on a surface of said cores to allow said second plastic material to fill in said at least one closed space.

26. The method of claim 25, wherein said second plastic enters said at least one closed space from behind said insert.

27. The method of claim 26, further comprising the steps of
providing a third mold to produce said insert; and
injecting a third plastic material in liquefied form into said third mold and forming said insert from said third plastic material.

28. The method of claim 27, wherein said third plastic material is the same as said first plastic material.

29. The method of claim 27, wherein said third plastic material is the same as said second plastic material but of a different color.
